(19) United States
(12) Patent Application Publication
(10) Pub. No.: US 2019/0200391 A1
(43) Pub. Date: Jun. 27, 2019

(54) Random Access Method and Apparatus

(71) Applicant: Huawei Technologies Co., Ltd., Shenzhen (CN)

(72) Inventors: Xiaocui Li, Beijing (CN); Kai Xu, Shenzhen (CN); Lili Zhang, Beijing (CN)

(21) Appl. No.: 16/099,381

(22) PCT Filed: May 12, 2016
(86) PCT No.: PCT/CN2016/081903

§ 371 Date: Nov. 6, 2018

(51) Int. Cl. H04W 74/08

(52) U.S. Cl. CPC H04W 74/0833

(57) ABSTRACT

A random access method and apparatus to increase an opportunity of performing physical random access channel (PRACH) access, where the method includes receiving, by a terminal, information about a PRACH time window from a base station, where the information about the PRACH time window carries a size of the PRACH time window, preempting, by the terminal, an unlicensed carrier on which a PRACH resource is configured, and performing, by the terminal before the size of the PRACH time window is exceeded, .PRACH access on the successfully preempted unlicensed carrier on which the PRACH resource is configured. Therefore, by configuring the PRACH time window, the terminal has more opportunities to preempt the unlicensed carrier on which the PRACH resource is configured, greatly improving a PRACH access success rate.

### TECHNICAL FIELD

The present invention relates to the field of communications technologies, and in particular, to a random access method and apparatus.

### BACKGROUND

Spectra used in a wireless communications system may be classified into two types, including a licensed spectrum (licensed spectrum) and an unlicensed spectrum (unlicensed spectrum). For a commercial mobile communications system, an operator needs to obtain a licensed spectrum through auction, and carry out operation activities of mobile communication by using the auctioned licensed spectrum. The unlicensed spectrum does not need to be auctioned, and anyone, for example, a WiFi device applied to a 2.4 GHz frequency band and a 5 GHz frequency band, can legally use these frequency bands.

In a licensed-assisted access using Long Term Evolution (Licensed-Assisted Access Using Long Term Evolution, LAA-LTE) system, a spectrum mainly used in the system is the unlicensed spectrum. In the LAA-LTE system, a node needs to use a channel resource by using a principle of listen before talk (listen before talk, LBT). LBT is a carrier sense multiple access (Carrier Sense Multiple Access, CSMA) technology. For example, in the LAA-LTE system, before sending a downlink message to a terminal, a base station first needs to preempt a channel resource. The downlink message that needs to be sent is sent by using the channel resource only after the channel resource is successfully preempted.

In the LAA-LTE system, for an uplink, a physical random access channel (physical random access channel, PRACH) plays a quite important role in a random access process of the terminal (User Equipment, UE). If the PRACH access of the terminal fails, uplink data cannot be sent in a timely manner, sounding reference signal (Sounding Reference Signal, SRS) detection cannot be performed on the channel in a timely manner, and so on. In the LAA-LTE system, the channel access principle of LBT needs to be conformed to. Therefore, both the base station and the UE may fail to preempt an unlicensed carrier to send a corresponding signal, leading to a PRACH access delay or failure.

### SUMMARY

Embodiments of the present invention provide a random access method and apparatus, to increase an opportunity of performing PRACH access.

Specific technical solutions provided in the embodiments of the present invention are as follows:

According to a first aspect, a random access method includes:

receiving, by a terminal, information about a PRACH time window sent by a base station, where the information about the PRACH time window carries a size of the PRACH time window;

preempting, by the terminal, an unlicensed carrier on which a PRACH resource is configured; and

performing, by the terminal before the size of the PRACH time window is exceeded, PRACH access on the successfully preempted unlicensed carrier on which the PRACH resource is configured.

Therefore, according to the method provided in this embodiment of the present invention, a PRACH access success rate is greatly improved by configuring the PRACH time window.

Optionally, the performing, by the terminal before the size of the PRACH time window is exceeded, PRACH access on the successfully preempted unlicensed carrier on which the PRACH resource is configured includes:

accessing, by the terminal before the size of the PRACH time window is exceeded, the unlicensed carrier on which the PRACH resource is configured, and detecting the PRACH resource within the PRACH time window; and

sending, by the terminal, a preamble preamble to the base station on a first detected PRACH resource.

Optionally, the information about the PRACH time window further carries a configuration rule of the PRACH resource and/or time-frequency resource information of the PRACH resource within the PRACH time window; and

the detecting, by the terminal, the PRACH resource within the PRACH time window includes:

detecting, by the terminal, the PRACH resource within the PRACH time window based on the configuration rule of the PRACH resource and/or the time-frequency resource information of the PRACH resource.

Optionally, the PRACH resource occupies non-consecutive resource blocks in frequency domain.

Optionally, the terminal receives, by using Radio Resource Control RRC signaling or physical downlink control channel PDCCH signaling, the information about the PRACH time window notified by the base station.

Optionally, the preempting, by the terminal, an unlicensed carrier on which a PRACH resource is configured includes:

determining, by the terminal, whether a sum of current duration for receiving downlink data and PRACH transmission duration is less than or equal to a maximum channel occupied time; and

if yes, preempting, by the terminal by using a preset channel access manner, the unlicensed carrier on which the PRACH resource is configured, or

otherwise, preempting, by the terminal by using a category-4 channel access manner, the unlicensed carrier on which the PRACH resource is configured.

Therefore, in a fast channel access manner proposed in this embodiment of the present invention, a process in which a channel is preempted through LBT is omitted, and a PRACH access success probability is increased.

Optionally, after the sending, by the terminal, a preamble to the base station on a first detected PRACH resource, the method further includes:

when receiving a random access response RAR time window message sent by the base station, receiving, by the terminal based on the RAR time window message, an RAR sent by the base station.

The RAR time window message carries a combination of at least one of the following information: an extension amount of an RAR time window, a latest size of the RAR time window, and a subframe offset of the RAR time window.

Optionally, the terminal receives, by using RRC signaling or PDCCH signaling, the RAR time window message sent by the base station.

Therefore, according to the method provided in this embodiment of the present invention, a success rate of preempting a channel by the base station is increased, and a PRACH access success rate of the terminal is increased.

Optionally, after the sending, by the terminal, a preamble to the base station on a first detected PRACH resource, and before the receiving an RAR sent by the base station, the method further includes:

receiving, by the terminal, first indication information sent by the base station by using a licensed carrier, where the first indication information is used for notifying the terminal that the base station successfully preempts an unlicensed carrier used for sending the RAR.

Optionally, after the receiving, by the terminal, an RAR sent by the base station, the method further includes:

sending, by the terminal, hybrid automatic repeat request-acknowledgment HARQ-ACK information to the base station by using a licensed carrier, where the HARQ-ACK information is used for notifying the base station that the terminal has received the RAR sent by the base station.

Therefore, the terminal can notify the base station of a random access success state of the terminal in a timely manner.

Optionally, after the sending, by the terminal, a preamble to the base station on a first detected PRACH resource, the method further includes:

when the terminal receives an RAR time window message sent by the base station, if it is determined based on the RAR time window message that an RAR sent by the base station is not received, and second indication information sent by the base station by using a licensed carrier is received, keeping transmit power unchanged when the preamble is sent next time.

The RAR time window message carries a combination of at least one of the following information: an extension amount of an RAR time window, a latest size of the RAR time window, and a subframe offset of the RAR time window. The second indication information is used for notifying the terminal that the base station does not successfully preempt an unlicensed carrier used for sending the RAR.

Therefore, the base station can notify, in a timely manner, the terminal whether the base station successfully preempts the unlicensed carrier used for sending the RAR. When determining that the base station does not successfully preempt the unlicensed carrier used for sending the RAR, the terminal does not need to improve power of sending the preamble next time.

According to a second aspect, a random access method includes:

generating, by a base station, information about a PRACH time window, where the information about the PRACH time window carries a size of the PRACH time window; and

sending, by the base station, the information about the PRACH time window to the terminal.

Optionally, the information about the PRACH time window further carries a configuration rule of the PRACH resource and/or time-frequency resource information of the PRACH resource within the PRACH time window.

Optionally, the PRACH resource occupies non-consecutive resource blocks in frequency domain.

Optionally, the base station notifies the terminal of the information about the PRACH time window by using RRC signaling or PDCCH signaling.

Optionally, after the sending, by the base station, the information about the PRACH time window to the terminal, the method further includes:

when the base station receives a preamble sent by the terminal, preempting, by the base station, an unlicensed carrier used for sending an RAR; and

sending, by the base station before a size of an RAR time window is exceeded, the RAR to the terminal on the successfully preempted unlicensed carrier used for sending the RAR.

Optionally, before the sending, by the base station, the RAR to the terminal on the successfully preempted unlicensed carrier used for sending the RAR, the method further includes:

sending, by the base station, first indication information to the terminal by using a licensed carrier, where the first indication information is used for notifying the terminal that the base station successfully preempts the unlicensed carrier used for sending the RAR.

Optionally, after the sending, by the base station, the RAR to the terminal on the successfully preempted unlicensed carrier used for sending the RAR, the method further includes:

receiving, by the base station, HARQ-ACK information sent by the terminal by using a licensed carrier, where the HARQ-ACK information is used for notifying the base station that the terminal has received the RAR sent by the base station.

Optionally, after the sending, by the base station, the information about the PRACH time window to the terminal, the method further includes:

when the base station receives a preamble sent by the terminal, preempting, by the base station, an unlicensed carrier used for sending an RAR; and

sending second indication information to the terminal by using a licensed carrier when the base station does not successfully preempt, before a size of an RAR time window is exceeded, the unlicensed carrier used for sending the RAR, where the second indication information is used for notifying the terminal that the base station does not successfully preempt the unlicensed carrier used for sending the RAR.

Optionally, before the preempting, by the base station, an unlicensed carrier used for sending an RAR, the method further includes:

sending, by the base station, an RAR time window message to the terminal, where the RAR time window message carries a combination of at least one of the following information: an extension amount of the RAR time window, a latest size of the RAR time window, and a subframe offset of the RAR time window.

Optionally, the RAR time window message is notified to the terminal by using the RRC signaling or the PDCCH signaling.

According to a third aspect, a random access apparatus includes:

a transceiver unit, configured to receive information about a PRACH time window sent by a base station, where the information about the PRACH time window carries a size of the PRACH time window; and

a processing unit, configured to: preempt an unlicensed carrier on which a PRACH resource is configured; and

perform, by using the transceiver unit before the size of the PRACH time window is exceeded, PRACH access on the successfully preempted unlicensed carrier on which the PRACH resource is configured.

Optionally, when performing, by using the transceiver unit before the size of the PRACH time window is exceeded, PRACH access on the successfully preempted unlicensed carrier on which the PRACH resource is configured, the processing unit is specifically configured to:

access, before the size of the PRACH time window is exceeded, the unlicensed carrier on which the PRACH resource is configured, and detect the PRACH resource within the PRACH time window; and

send a preamble preamble to the base station on a first detected PRACH resource by using the transceiver unit.

Optionally, the information about the PRACH time window further carries a configuration rule of the PRACH resource and/or time-frequency resource information of the PRACH resource within the PRACH time window; and

when detecting the PRACH resource within the PRACH time window, the processing unit is specifically configured to:

detect the PRACH resource within the PRACH time window based on the configuration rule of the PRACH resource and/or the time-frequency resource information of the PRACH resource.

Optionally, the PRACH resource occupies non-consecutive resource blocks in frequency domain.

Optionally, the transceiver unit receives, by using RRC signaling or PDCCH signaling, the information about the PRACH time window notified by the base station.

Optionally, when preempting the unlicensed carrier on which the PRACH resource is configured, the processing unit is specifically configured to:

determine whether a sum of current duration for receiving downlink data and PRACH transmission duration is less than or equal to a maximum channel occupied time; and

if yes, preempt, by using a preset channel access manner, the unlicensed carrier on which the PRACH resource is configured, or

otherwise, preempt, by using a category-4 channel access manner, the unlicensed carrier on which the PRACH resource is configured.

Optionally, the processing unit is further configured to:

after the preamble is sent to the base station on the first detected PRACH resource, and when a random access response RAR time window message sent by the base station is received, receive, based on the RAR time window message by using the transceiver unit, an RAR sent by the base station.

The RAR time window message carries a combination of at least one of the following information: an extension amount of an RAR time window, a latest size of the RAR time window, and a subframe offset of the RAR time window.

Optionally, the transceiver unit receives, by using RRC signaling or PDCCH signaling, the RAR time window message sent by the base station.

Optionally, the transceiver unit is further configured to:

after the preamble is sent to the base station on the first detected PRACH resource, and before the RAR sent by the base station is received, receive first indication information sent by the base station by using a licensed carrier, where the first indication information is used for notifying the apparatus that the base station successfully preempts an unlicensed carrier used for sending the RAR.

Optionally, the transceiver unit is further configured to:

send hybrid automatic repeat request-acknowledgment HARQ-ACK information to the base station by using a licensed carrier after the RAR sent by the base station is received, where the HARQ-ACK information is used for notifying the base station that the apparatus has received the RAR sent by the base station.

Optionally, the processing unit is further configured to:

after the preamble is sent to the base station on the first detected PRACH resource, and when an RAR time window message sent by the base station is received, if it is determined based on the RAR time window message that an RAR sent by the base station is not received, and second indication information sent by the base station by using a licensed carrier is received, keep transmit power unchanged when the preamble is sent next time.

The RAR time window message carries a combination of at least one of the following information: an extension amount of an RAR time window, a latest size of the RAR time window, and a subframe offset of the RAR time window. The second indication information is used for notifying the apparatus that the base station does not successfully preempt an unlicensed carrier used for sending the RAR.

According to a fourth aspect, a random access apparatus includes:

a processing unit, configured to generate information about a PRACH time window, where the information about the PRACH time window carries a size of the PRACH time window; and

a transceiver unit, configured to send the information about the PRACH time window to the terminal.

Optionally, the information about the PRACH time window further carries a configuration rule of a PRACH resource and/or time-frequency resource information of the PRACH resource within the PRACH time window.

Optionally, the PRACH resource occupies non-consecutive resource blocks in frequency domain.

Optionally, the transceiver unit notifies the terminal of the information about the PRACH time window by using RRC signaling or PDCCH signaling.

Optionally, the processing unit is further configured to:

after the information about the PRACH time window is sent to the terminal, and when a preamble sent by the terminal is received, preempt an unlicensed carrier used for sending an RAR; and

send, by using the transceiver unit before a size of an RAR time window is exceeded, the RAR to the terminal on the successfully preempted unlicensed carrier used for sending the RAR.

Optionally, the transceiver unit is further configured to:

send first indication information to the terminal by using a licensed carrier before the RAR is sent to the terminal on the successfully preempted unlicensed carrier used for sending the RAR, where the first indication information is used for notifying the terminal that the apparatus successfully preempts the unlicensed carrier used for sending the RAR.

Optionally, the transceiver unit is further configured to:

after the RAR is sent to the terminal on the successfully preempted unlicensed carrier used for sending the RAR, receive HARQ-ACK information sent by the terminal by using a licensed carrier, where the HARQ-ACK information is used for notifying the apparatus that the terminal has received the RAR sent by the base station.

Optionally, the processing unit is further configured to:

after the information about the PRACH time window is sent to the terminal, and when a preamble sent by the terminal is received, preempt an unlicensed carrier used for sending an RAR; and

send second indication information to the terminal by using the transceiver unit by using a licensed carrier when the unlicensed carrier used for sending the RAR is not successfully preempted before a size of an RAR time window is exceeded, where the second indication information is used for notifying the terminal that the apparatus does not successfully preempt the unlicensed carrier used for sending the RAR.

Optionally, the transceiver unit is further configured to:

send an RAR time window message to the terminal before the unlicensed carrier used for sending the RAR is preempted, where the RAR time window message carries a combination of at least one of the following information: an extension amount of the RAR time window, a latest size of the RAR time window, and a subframe offset of the RAR time window.

Optionally, the transceiver unit notifies the terminal of the RAR time window message by using the RRC signaling or the PDCCH signaling.

According to a fifth aspect, an embodiment of the present invention provides a random access device, including a transceiver, a processor, and a memory. The transceiver, the processor, and the memory are connected to each other by using a bus.

The transceiver is configured to receive information about a PRACH time window sent by a base station. The information about the PRACH time window carries a size of the PRACH time window.

The memory is configured to store program code executed by the processor.

The processor is configured to perform the following operations by using the program code in the memory: preempting an unlicensed carrier on which a PRACH resource is configured; and

performing, by using the transceiver before the size of the PRACH time window is exceeded, PRACH access on the successfully preempted unlicensed carrier on which the PRACH resource is configured.

According to a sixth aspect, an embodiment of the present invention provides a random access device, including a transceiver, a processor, and a memory. The transceiver, the processor, and the memory are connected to each other by using a bus.

The memory is configured to store program code executed by the processor.

The processor is configured to perform the following operation by using the program code in the memory: generating information about a PRACH time window, where the information about the PRACH time window carries a size of the PRACH time window.

The transceiver is configured to send the information about the PRACH time window to a terminal.

Beneficial effects of the embodiments of the present invention are as follows: The terminal receives the information about the PRACH time window sent by the base station. The information about the PRACH time window carries the size of the PRACH time window. In other words, the base station configures the PRACH time window for current random access of the terminal. The terminal preempts the unlicensed carrier on which the PRACH resource is configured, and performs, before the size of the PRACH time window is exceeded, PRACH access on the successfully preempted unlicensed carrier on which the PRACH resource is configured. Therefore, by configuring the PRACH time window, the terminal may have more time to preempt the unlicensed carrier on which the PRACH resource is configured, greatly improving a PRACH access success rate.

### BRIEF DESCRIPTION OF DRAWINGS

FIG. 1 is a flowchart of non-contention based random access in conventional LTE according to an embodiment of the present invention;

FIG. 2 is a first flowchart summarizing a random access process according to an embodiment of the present invention;

FIG. 3 is a schematic distribution diagram of current duration for receiving downlink data and PRACH transmission duration in a maximum channel occupied time according to an embodiment of the present invention;

FIG. 4 is a schematic diagram of a configuration rule of a PRACH resource according to an embodiment of the present invention;

FIG. 5 is a schematic diagram of an RAR time window according to an embodiment of the present invention;

FIG. 6 is a detailed flowchart of successful random access by UE 1 according to an embodiment of the present invention;

FIG. 7 is a second flowchart summarizing a random access process according to an embodiment of the present invention;

FIG. 8 is a first schematic structural diagram of a random access apparatus according to an embodiment of the present invention;

FIG. 9 is a second schematic structural diagram of a random access apparatus according to an embodiment of the present invention;

FIG. 10 is a first schematic structural diagram of a random access device according to an embodiment of the present invention; and

FIG. 11 is a second schematic structural diagram of a random access device according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by persons of ordinary skill in the art based on the embodiments of the present invention without creative efforts shall fall within the protection scope of the present invention.

The embodiments of the present invention provide a random access method and apparatus, to increase an opportunity of performing PRACH access. The method and the apparatus are based on a same inventive concept. The method and the apparatus have similar principles to resolve a problem. Therefore, for implementation of the method and the apparatus, refer to each other, and repeated content is not described again.

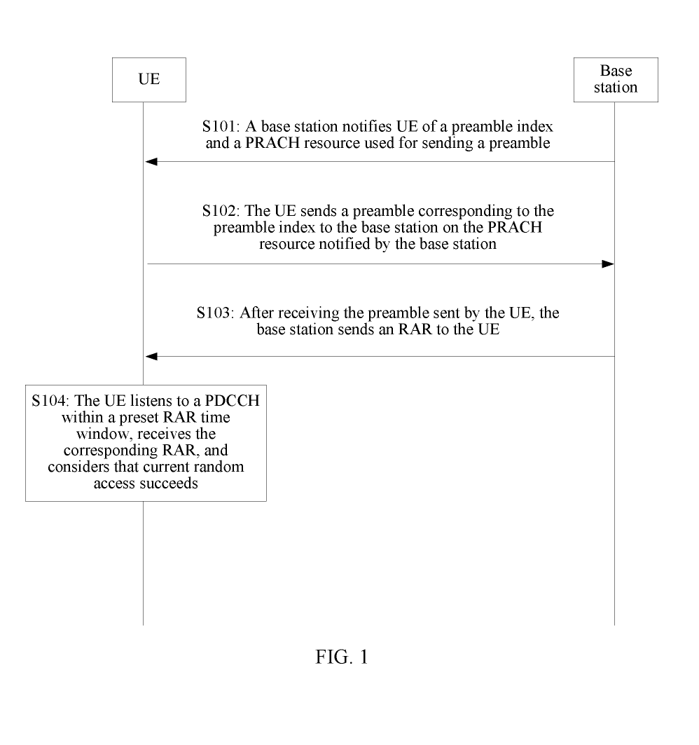

In the prior art, referring to FIG. 1, a non-contention based random access process in conventional LTE is as follows:

S101: A base station notifies UE of a preamble index (preamble index) and a PRACH resource used for sending a preamble.

S102: The UE sends a preamble corresponding to the preamble index to the base station on the PRACH resource notified by the base station.

S103: After receiving the preamble sent by the UE, the base station sends a random access response (random access response, RAR) to the UE.

S104: The UE listens to a physical downlink control channel (Physical Downlink Control Channel, PDCCH) within a preset RAR time window, and receives the corresponding RAR.

If the UE receives, within the RAR time window, an RAR matching a random access radio network temporary identifier (Random Access Radio Network Temporary Identifier, RA-RNTI) of the UE, it is considered that a current random access process succeeds.

If the UE receives no RAR within the RAR time window, to be specific, receives no RAR matching the RA-RNTI of the UE, it is considered that a current random access process fails. If the random access process fails and the UE does not reach a maximum quantity of random access attempts (preambleTransMax), the UE increases, based on previous transmit power, power of sending the preamble next time (powerRampingStep), to improve a transmission success probability.

In the following, preferred implementations of the present invention are described in detail with reference to the accompanying drawings.

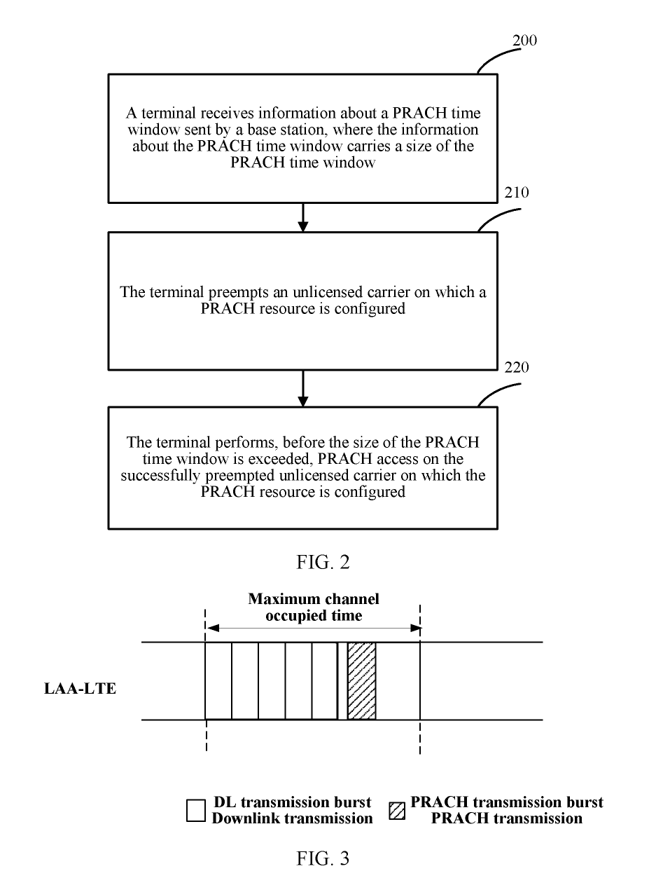

Referring to FIG. 2, an embodiment of the present invention provides a random access method. The method includes the following steps.

Step 200: A terminal receives information about a PRACH time window sent by a base station, where the information about the PRACH time window carries a size of the PRACH time window.

Step 210: The terminal preempts an unlicensed carrier on which a PRACH resource is configured.

Step 220: The terminal performs, before the size of the PRACH time window is exceeded, PRACH access on the successfully preempted unlicensed carrier on which the PRACH resource is configured.

If the terminal does not successfully preempt, within the PRACH time window, the unlicensed carrier on which the PRACH resource is configured, current random access is discarded.

When step 210 is performed, optionally, when the terminal preempts the unlicensed carrier on which the PRACH resource is configured, the terminal first determines whether a sum of current duration for receiving downlink data and PRACH transmission duration is less than or equal to a maximum channel occupied time. If yes, the terminal preempts, by using a preset channel access manner, the unlicensed carrier on which the PRACH resource is configured. The preset channel access manner may mean that a channel is accessed through category 2. Alternatively, a fast channel access manner may be used. That is, a channel can be directly accessed provided that the channel is detected to be idle in 25 microseconds. Otherwise, the terminal preempts, by using a category-4 channel access manner, the unlicensed carrier on which the PRACH resource is configured.

Specifically, in LAA, for an LAA downlink, category 4 is used as a basic channel access manner. In an LAA project in 3GPP REL.13, four channel access manners are defined.

category 1 refers to a channel access manner in which transmission may be directly performed according to a rule without performing LBT, and a short control message is an example of category 1.

category 2 refers to an LBT channel access manner without a random backoff mechanism, and frame-based periodic channel detection (frame based equipment, FBE) is an example of category 2.

category 3 refers to an LBT channel access manner with a random backoff mechanism and an unchanged contention window size, and channel detection triggered based on arrival of a service data packet (Load based equipment, LBE) is an example of category 3.

category 4 refers to an LBT channel access manner with a random backoff mechanism and a changeable contention window size.

For a specific channel access procedure in category 4, before data is transmitted, clear channel assessment (Clear Channel Assessment, CCA) first needs to be performed on a channel. If the channel is idle, the data is directly sent. In this way, an unlicensed carrier is successfully preempted. If it is found that the channel is occupied, extended channel assessment (Extended CCA, ECCA) needs to be performed. An ECCA process is a process of finding N unoccupied idle slots (unoccupied idle slot). A value of N is [1, q], q is the contention window size, and a range of a value of q is [X, Y], When ECCA is performed each time, the value of q changes, and the value of N is randomly selected each time. When an unoccupied idle slot is found, 1 is subtracted from the value of N until N=0. Then, the data can be sent. In this way, the unlicensed carrier is successfully preempted.

However, for a random access process, this embodiment of the present invention proposes that if the sum of the current duration for receiving the downlink data and the PRACH transmission duration is less than or equal to the maximum channel occupied time (Maximum Channel Occupied Time, MCOT), the terminal preempts, by using the preset channel access manner, the unlicensed carrier on which the PRACH resource is configured. The PRACH transmission duration is duration required for a current random access process. As shown in FIG. 3, the base station already performs channel access through LBT before sending the downlink data. Therefore, when initiating the PRACH access within one MCOT time, in other words, when preempting the unlicensed carrier on which the PRACH is configured, the terminal may use the fast channel access manner. That is, a channel can be directly accessed provided that the channel is detected to be idle in 25 microseconds. In this way, the unlicensed carrier on which the PRACH is configured is successfully preempted. If the sum of the current duration for receiving the downlink data and the PRACH transmission duration is greater than the maximum channel occupied time, the terminal needs to preempt, by using the foregoing category-4 channel access manner, the unlicensed carrier on which the PRACH resource is configured.

Therefore, in the fast channel access manner proposed in this embodiment of the present invention, a process in which a channel is preempted through LBT is omitted, and a PRACH access success probability is increased.

When step 220 is performed, the terminal successfully preempts, before the size of the PRACH time window is exceeded, the unlicensed carrier on which the PRACH resource is configured, and detects the PRACH resource within the PRACH time window. The terminal sends a preamble to the base station on a first detected PRACH resource.

Optionally, the information about the PRACH time window further carries a configuration rule of the PRACH resource and/or time-frequency resource information of the PRACH resource within the PRACH time window.

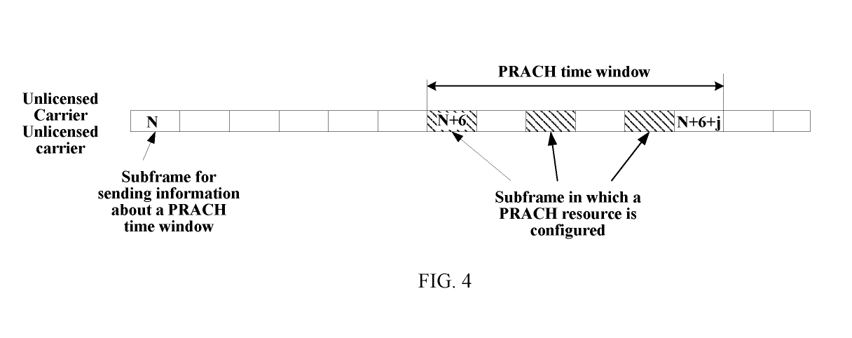

The configuration rule of the PRACH resource may be that the PRACH resource is periodically configured within the PRACH window. For example, the configuration period is one subframe or two subframes. That is, the PRACH resource is configured on each subframe or every two subframes. For example, referring to FIG. 4, the configuration rule of the PRACH resource may be that the PRACH resource is configured on three subframes with oblique lines within the PRACH time window. The foregoing examples are merely illustrative, and a specific periodic configuration is not limited thereto.

The configuration rule of the PRACH resource may alternatively be that the PRACH resource is aperiodically configured within the PRACH window. For example, the PRACH resource is configured on several selected particular subframes.

In addition, the information about the PRACH time window may further include the time-frequency resource information of the PRACH resource. In frequency domain, the PRACH resource may occupy non-consecutive resource blocks or consecutive resource blocks.

Specifically, the PRACH resource occupies non-consecutive resource blocks in frequency domain. Occupying non-consecutive resource blocks means that the PRACH resource is discretely distributed in frequency domain. To be specific, the resource blocks occupied by the PRACH resource may be partially consecutive and partially non-consecutive, none of the resource blocks are consecutive, or the like. Certainly, descriptions of the non-consecutive resource blocks herein are merely used as an example, and is not limited thereto.

The information about the PRACH time window is notified to the terminal through semi-static configuration by using Radio Resource Control (Radio Resource Control, RRC) signaling or through dynamic indication by using PDCCH signaling.

Optionally, when the terminal detects the PRACH resource within the PRACH time window, the terminal may further detect the PRACH resource based on the configuration rule of the PRACH resource and/or the time-frequency resource information of the PRACH resource within the PRACH time window.

For example, referring to FIG. 4, the terminal receives, on a subframe N, the information about the PRACH time window sent by the base station. The information includes the size of the PRACH time window (for example, from a subframe N+6 to a subframe N+6+j) and the configuration rule of the PRACH resource (for example, the PRACH resource is configured on three subframes with oblique lines). After receiving the information about the PRACH time window sent by the base station, the terminal starts to preempt the unlicensed carrier on which the PRACH resource is configured. Assuming that the terminal preempts, before the subframe N+6, the unlicensed carrier on which the PRACH resource is configured, the terminal detects a first PRACH resource in the subframe N+6, and sends the preamble on the PRACH resource. Alternatively, assuming that the unlicensed carrier on which the PRACH resource is configured is not successfully preempted until in a subframe N+7, the terminal starts to detect the PRACH resource in a subframe N+8, and sends the preamble on a first detected PRACH resource.

Therefore, according to the method provided in this embodiment of the present invention, a PRACH access success rate is greatly improved by configuring the PRACH time window. After the terminal sends the preamble to the base station on the first detected PRACH resource, the terminal receives an RAR sent by the base station. To be specific, if UE receives, within an RAR time window, an RAR matching an RA-RNTI of the UE, it is considered that a current random access process succeeds.

In conventional LTE, the RAR time window begins from a third subframe that is after a subframe in which a preamble is sent, and lasts for subframes of a size of the RAR time window (ra-ResponseWindowSize). In LAA, the RAR may be sent to the UE by using a licensed carrier. This may ensure that there is no delay. The RAR may alternatively be transmitted on an unlicensed carrier, and the base station needs to preempt a channel through LBT. Consequently, a transmission delay may be caused. In this embodiment of the present invention, to increase a success rate of preempting a channel by the base station, the RAR time window may be extended or the RAR time window may be shifted backward.

For example, the RAR time window is extended. As shown in a specific configuration of the following ra-ResponseWindowSize, in the conventional LTE, a window size may be a value such as sf2, sf3, sf4, sf5, sf6, sf7, sf8, or sf10, where sf refers to a subframe. To be specific, sf2 means that the size of the RAR time window is two subframes. In the LAA, the base station needs to preempt a channel through LBT, and this may cause a transmission delay. Therefore, the RAR window may be extended. For example, the size of the RAR window may be increased to sf15, sf20, or the like, and sf15 and sf20 are merely used as examples. This is not limited thereto.

For another example, the RAR time window is shifted backward. An offset k (k≥0) means that the RAR time window changes from an original start position of an (N+3)^{th} subframe to a start position of an (N+3+K)^{th} subframe.

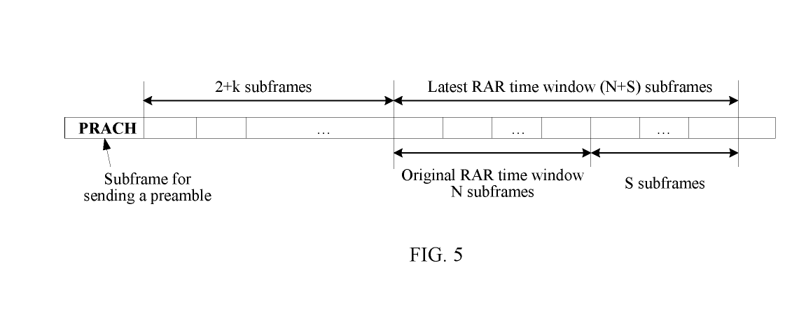

In FIG. 5, the RAR time window is shifted backward by k subframes, and an original RAR time window is increased from N subframes to (N+S) subframes.

Optionally, before preempting the unlicensed carrier used for sending the RAR, the base station sends an RAR time window message to the terminal. The RAR time window message carries a combination of at least one of the following information: an extension amount of an RAR time window, a latest size of the RAR time window, and a subframe offset of the RAR time window.

Optionally, the RAR time window message is notified to the terminal by using RRC signaling or PDCCH signaling. The RAR time window message may be used for instructing the terminal to listen to a PDCCH within the RAR time window and receive the RAR.

Therefore, according to the method provided in this embodiment of the present invention, a success rate of preempting a channel by the base station is increased, and a PRACH access success rate of the terminal is increased.

Optionally, after the terminal sends the preamble to the base station on the first detected PRACH resource, and when the base station receives the preamble sent by the terminal, the base station preempts the unlicensed carrier used for sending the RAR.

If the base station successfully preempts, before the size of the RAR time window is exceeded, the unlicensed carrier used for sending the RAR, the base station sends first indication information to the terminal by using a licensed carrier. The first indication information is used for notifying the terminal that the base station successfully preempts the unlicensed carrier used for sending the RAR. If the base station does not successfully preempt, before the size of the RAR time window size is exceeded, the unlicensed carrier used for sending the RAR, the base station sends second indication information to the terminal by using a licensed carrier. The second indication information is used for notifying the terminal that the base station does not successfully preempt the unlicensed carrier used for sending the RAR. In this case, if the terminal determines no RAR sent by the base station is received within the RAR time window, the terminal keeps, power of sending the preamble unchanged when resending the preamble next time.

The first indication information and the second indication information herein may be one piece of indication information indicated by using two different bits. For example, “0” indicates that the unlicensed carrier used for sending the RAR is not successfully preempted, and “1” indicates that the unlicensed carrier used for sending the RAR is successfully preempted.

In the conventional LTE, although the UE receives the RAR, a physical uplink shared channel (Physical Uplink Shared Channel, PUSCH) resource can be sent only after the UE successfully preempts a channel. If the UE does not successfully preempt the channel but send a corresponding PUSCH, the base station considers that the RAR is not successfully sent. Therefore, this embodiment of the present invention further proposes that after the terminal receives the RAR sent by the base station, the terminal may further send hybrid automatic repeat request-acknowledgment (Hybrid Automatic Repeat request, HARQ) information to the base station by using a licensed carrier. The HARQ-ACK information is used for notifying the base station that the terminal has received the RAR sent by the base station. Therefore, the base station learns that current random access of the UE succeeds, and waits for the UE to send a corresponding PUSCH.

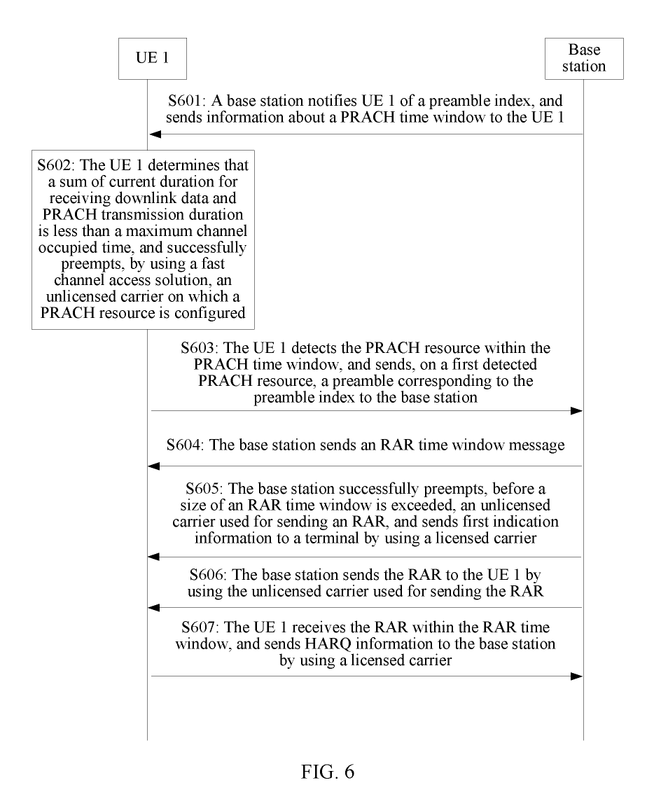

Referring to FIG. 6, a detailed process in which UE 1 successfully performs random access is as follows.

S601: A base station notifies the UE 1 of a preamble index, and sends information about a PRACH time window to the UE 1.

For example, the information about the PRACH time window carries a size of the PRACH time window.

S602: The UE 1 determines that a sum of current duration for receiving downlink data and PRACH transmission duration is less than a maximum channel occupied time, and successfully preempts, by using a fast channel access manner, an unlicensed carrier on which a PRACH resource is configured.

S603: The UE 1 detects the PRACH resource within the PRACH time window, and sends, on a first detected PRACH resource, a preamble corresponding to the preamble index to the base station.

S604: The base station sends an RAR time window message.

For example, the RAR time window message carries a subframe offset of an RAR time window.

S605: The base station successfully preempts, before a size of an RAR time window is exceeded, an unlicensed carrier used for sending an RAR, and sends first indication information to a terminal by using a licensed carrier.

The first indication information is used for notifying the terminal that the base station successfully preempts the unlicensed carrier used for sending the RAR.

S606: The base station sends the RAR to the UE 1 by using the unlicensed carrier used for sending the RAR.

S607: The UE 1 receives the RAR within the RAR time window, and sends HARQ information to the base station by using a licensed carrier.

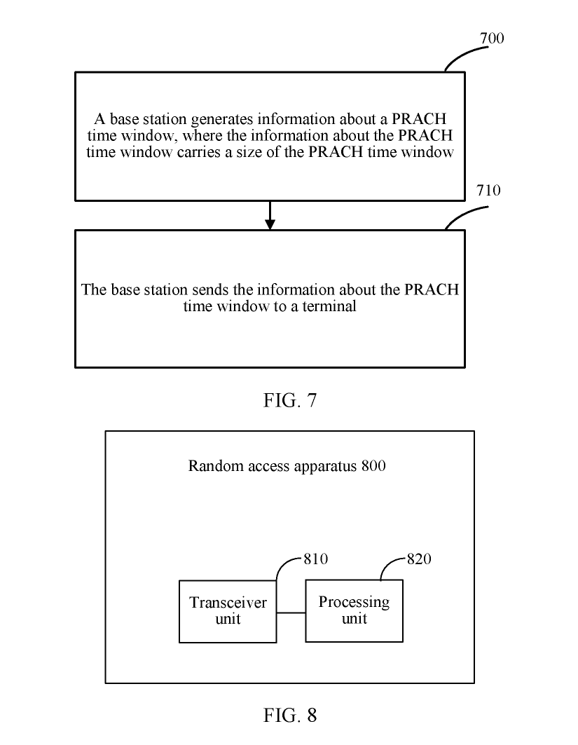

Based on the same inventive concept as the embodiments corresponding to FIG. 2 to FIG. 6, this application further provides a random access method. Repeated content in this embodiment and the embodiments corresponding to FIG. 2 to FIG. 6 is not described again. Referring to FIG. 7, this embodiment of the present invention provides a random access method. The method includes the following steps.

Step 700: A base station generates information about a PRACH time window, where the information about the PRACH time window carries a size of the PRACH time window.

Step 710: The base station sends the information about the PRACH time window to a terminal.

Optionally, the information about the PRACH time window further carries a configuration rule of a PRACH resource and/or time-frequency resource information of the PRACH resource within the PRACH time window.

Optionally, the PRACH resource occupies non-consecutive resource blocks in frequency domain.

Optionally, the information about the PRACH time window is notified to the terminal by using RRC signaling or PDCCH signaling.

Optionally, after the sending, by the base station, the information about the PRACH time window to a terminal, the method further includes:

when the base station receives a preamble sent by the terminal, preempting, by the base station, an unlicensed carrier used for sending an RAR; and

sending, by the base station before a size of an RAR time window is exceeded, the RAR to the terminal on the successfully preempted unlicensed carrier used for sending the RAR.

Optionally, before the sending, by the base station, the RAR to the terminal on the successfully preempted unlicensed carrier used for sending the RAR, the method further includes:

sending, by the base station, first indication information to the terminal by using a licensed carrier, where the first indication information is used for notifying the terminal that the base station successfully preempts the unlicensed carrier used for sending the RAR.

Optionally, after the sending, by the base station, the RAR to the terminal on the successfully preempted unlicensed carrier used for sending the RAR, the method further includes:

receiving, by the base station, HARQ-ACK information sent by the terminal by using a licensed carrier, where the HARQ-ACK information is used for notifying the base station that the terminal has received the RAR sent by the base station.

Optionally, after the sending, by the base station, the information about the PRACH time window to a terminal, the method further includes:

when the base station receives a preamble sent by the terminal, preempting, by the base station, an unlicensed carrier used for sending an RAR; and

sending, by the base station, second indication information to the terminal by using a licensed carrier when the base station does not successfully preempt, before a size of an RAR time window is exceeded, the unlicensed carrier used for sending the RAR, where the second indication information is used for notifying the terminal that the base station does not successfully preempt the unlicensed carrier used for sending the RAR.

Optionally, before the preempting, by the base station, an unlicensed carrier used for sending an RAR, the method further includes:

sending, by the base station, an RAR time window message to the terminal, where the RAR time window message carries a combination of at least one of the following information: an extension amount of the RAR time window, a latest size of the RAR time window, or a subframe offset of the RAR time window.

Optionally, the RAR time window message is notified to the terminal by using the RRC signaling or the PDCCH signaling.

Based on the same inventive concept, an embodiment of the present invention further provides a random access apparatus. The apparatus may be the terminal in the embodiment shown in FIG. 2, and may be configured to perform the method embodiment corresponding to FIG. 2. Therefore, for an implementation of the random access apparatus provided in this embodiment of the present invention, refer to the implementation of the method, and repeated content is not described again.

Referring to FIG. 8, an embodiment of the present invention provides a random access apparatus 800, including:

a transceiver unit 810, configured to receive information about a PRACH time window sent by a base station, where the information about the PRACH time window carries a size of the PRACH time window; and

a processing unit 820, configured to: preempt an unlicensed carrier on which a PRACH resource is configured; and

perform, by using the transceiver unit 810 before the size of the PRACH time window is exceeded, PRACH access on the successfully preempted unlicensed carrier on which the PRACH resource is configured.

Optionally, when performing, by using the transceiver unit 810 before the size of the PRACH time window is exceeded, PRACH access on the successfully preempted unlicensed carrier on which the PRACH resource is configured, the processing unit 820 is specifically configured to:

access, before the size of the PRACH time window is exceeded, the unlicensed carrier on which the PRACH resource is configured, and detect the PRACH resource within the PRACH time window; and

send a preamble preamble to the base station on a first detected PRACH resource by using the transceiver unit 810.

Optionally, the information about the PRACH time window further carries a configuration rule of the PRACH resource and/or time-frequency resource information of the PRACH resource within the PRACH time window.

When detecting the PRACH resource within the PRACH time window, the processing unit 820 is specifically configured to:

detect the PRACH resource within the PRACH time window based on the configuration rule of the PRACH resource and/or the time-frequency resource information of the PRACH resource.

Optionally, the PRACH resource occupies non-consecutive resource blocks in frequency domain.

Optionally, the transceiver unit 810 receives, by using RRC signaling or PDCCH signaling, the information about the PRACH time window notified by the base station.

Optionally, when preempting the unlicensed carrier on which the PRACH resource is configured, the processing unit 820 is specifically configured to:

determine whether a sum of current duration for receiving downlink data and PRACH transmission duration is less than or equal to a maximum channel occupied time; and

if yes, preempt, by using a preset channel access manner, the unlicensed carrier on which the PRACH resource is configured, or

otherwise, preempt, by using a category-4 channel access manner, the unlicensed carrier on which the PRACH resource is configured.

Optionally, the processing unit 820 is further configured to:

after the preamble is sent to the base station on the first detected PRACH resource, and when a random access response RAR time window message sent by the base station is received, receive, based on the RAR time window message by using the transceiver unit 810, an RAR sent by the base station.

The RAR time window message carries a combination of at least one of the following information: an extension amount of an RAR time window, a latest size of the RAR time window, and a subframe offset of the RAR time window.

Optionally, the transceiver unit 810 receives, by using RRC signaling or PDCCH signaling, the RAR time window message sent by the base station.

Optionally, the transceiver unit 810 is further configured to:

after the preamble is sent to the base station on the first detected PRACH resource, and before the RAR sent by the base station is received, receive first indication information sent by the base station by using a licensed carrier, where the first indication information is used for notifying the apparatus that the base station successfully preempts an unlicensed carrier used for sending the RAR.

Optionally, the transceiver unit 810 is further configured to:

send hybrid automatic repeat request-acknowledgment HARQ-ACK information to the base station by using a licensed carrier after the RAR sent by the base station is received, where the HARQ-ACK information is used for notifying the base station that the apparatus has received the RAR sent by the base station.

Optionally, the processing unit 820 is further configured to:

after the preamble is sent to the base station on the first detected PRACH resource, and when an RAR time window message sent by the base station is received, if it is determined based on the RAR time window message that an RAR sent by the base station is not received, and second indication information sent by the base station by using a licensed carrier is received, keep transmit power unchanged when the preamble is sent next time.

The RAR time window message carries a combination of at least one of the following information: an extension amount of an RAR time window, a latest size of the RAR time window, and a subframe offset of the RAR time window. The second indication information is used for notifying the apparatus that the base station does not successfully preempt an unlicensed carrier used for sending the RAR.

Based on the same inventive concept, an embodiment of the present invention further provides a random access apparatus. The apparatus may be the base station in the embodiment shown in FIG. 7, and may be configured to perform the method embodiment corresponding to FIG. 7. Therefore, for an implementation of the random access apparatus provided in this embodiment of the present invention, refer to the implementation of the method, and repeated content is not described again.

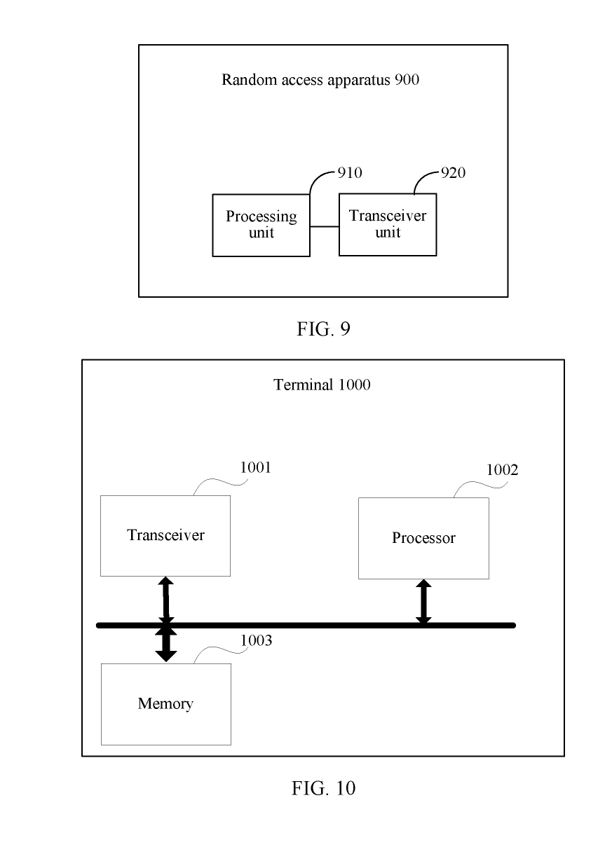

Referring to FIG. 9, this embodiment of the present invention provides a random access apparatus 900, including:

a processing unit 910, configured to generate information about a PRACH time window, where the information about the PRACH time window carries a size of the PRACH time window; and

a transceiver unit 920, configured to send the information about the PRACH time window to the terminal.

Optionally, the information about the PRACH time window further carries a configuration rule of a PRACH resource and/or time-frequency resource information of the PRACH resource within the PRACH time window.

Optionally, the PRACH resource occupies non-consecutive resource blocks in frequency domain.

Optionally, the transceiver unit 920 notifies the terminal of the information about the PRACH time window by using RRC signaling or PDCCH signaling.

Optionally, the processing unit 910 is further configured to:

after the information about the PRACH time window is sent to the terminal, and when a preamble sent by the terminal is received, preempt an unlicensed carrier used for sending an RAR; and

send, by using the transceiver unit 920 before a size of an RAR time window is exceeded, the RAR to the terminal on the successfully preempted unlicensed carrier used for sending the RAR.

Optionally, the transceiver unit 920 is further configured to:

send first indication information to the terminal by using a licensed carrier before the RAR is sent to the terminal on the successfully preempted unlicensed carrier used for sending the RAR, where the first indication information is used for notifying the terminal that the apparatus successfully preempts the unlicensed carrier used for sending the RAR.

Optionally, the transceiver unit 920 is further configured to:

after the RAR is sent to the terminal on the successfully preempted unlicensed carrier used for sending the RAR, receive HARQ-ACK information sent by the terminal by using a licensed carrier, where the HARQ-ACK information is used for notifying the apparatus that the terminal has received the RAR sent by the base station.

Optionally, the processing unit 910 is further configured to:

after the information about the PRACH time window is sent to the terminal, and when a preamble sent by the terminal is received, preempt an unlicensed carrier used for sending an RAR; and

send second indication information to the terminal by using the transceiver unit by using a licensed carrier when the unlicensed carrier used for sending the RAR is not successfully preempted before a size of an RAR time window is exceeded, where the second indication information is used for notifying the terminal that the base station does not successfully preempt the unlicensed carrier used for sending the RAR.

Optionally, the transceiver unit 920 is further configured to:

send an RAR time window message to the terminal before the unlicensed carrier used for sending the RAR is preempted, where the RAR time window message carries a combination of at least one of the following information: an extension amount of the RAR time window, a latest size of the RAR time window, and a subframe offset of the RAR time window.

Optionally, the transceiver unit 920 notifies the terminal of the RAR time window message by using the RRC signaling or the PDCCH signaling.

It should be noted that module division in the embodiments of the present invention is an example and is merely logical function division. During actual implementation, there may be another division manner. In addition, functional modules in the embodiments of this application may be integrated into a processing module, or each of the modules may exist alone physically, or two or more modules are integrated into one module. The integrated module may be implemented in a form of hardware, or may be implemented in a form of a software functional module.

When the integrated module is implemented in the form of a software functional module and sold or used as an independent product, the integrated module may be stored in a computer-readable storage medium. Based on such an understanding, the technical solutions of this application essentially, or a part contributing to the prior art, or all or a part of the technical solutions may be implemented in a form of a software product. The computer software product is stored in a storage medium and includes several instructions for enabling a computer device (which may be a personal computer, a server, a network device, or the like) or a processor (processor) to perform all or some steps of the methods described in the embodiments of this application. The foregoing storage medium includes any medium that can store program code, such as a USB flash drive, a removable hard disk, a read-only memory (ROM, Read-Only Memory), a random access memory (RAM, Random Access Memory), a magnetic disk, or an optical disc.

Based on the same inventive concept, an embodiment of the present invention further provides a random access device. The random access device may be the terminal in the embodiment shown in FIG. 2, or the apparatus in the embodiment shown in FIG. 8. Therefore, for an implementation of the random access device provided in this embodiment of the present invention, refer to the implementations of the embodiments shown in FIG. 2 and FIG. 8, and repeated content is not described again.

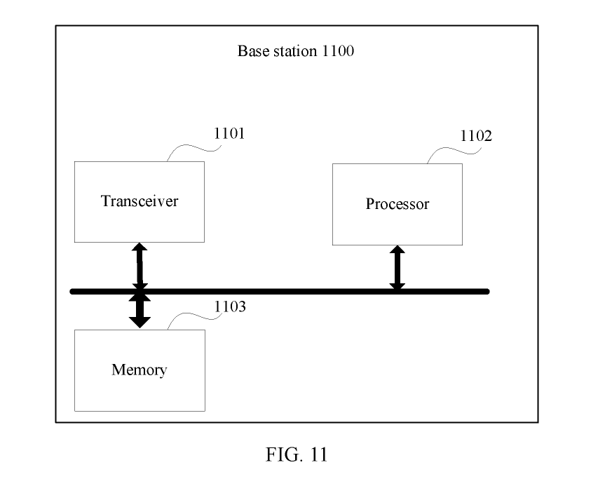

Referring to FIG. 10, this embodiment of the present invention provides a random access device, including a transceiver 1001, a processor 1002, and a memory 1003. The transceiver 1001, the processor 1002, and the memory 1003 are connected to each other by using a bus.

The transceiver 1001 is configured to receive information about a PRACH time window sent by a base station. The information about the PRACH time window carries a size of the PRACH time window.

The memory 1003 is configured to store program code executed by the processor 1002.

The processor 1002 is configured to perform the following operations by using the program code in the memory 1003: preempting an unlicensed carrier on which a PRACH resource is configured; and

performing, by using the transceiver 1001 before the size of the PRACH time window is exceeded, PRACH access on the successfully preempted unlicensed carrier on which the PRACH resource is configured.

Based on the same inventive concept, an embodiment of the present invention further provides a random access device. The random access device may be the base station in the embodiment shown in FIG. 7, or the apparatus in the embodiment shown in FIG. 9. Therefore, for an implementation of the random access device provided in this embodiment of the present invention, refer to the implementations of the embodiments shown in FIG. 7 and FIG. 9, and repeated content is not described again.

Referring to FIG. 11, this embodiment of the present invention provides a random access device, including a transceiver 1101, a processor 1102, and a memory 1103. The transceiver 1101, the processor 1102, and the memory 1103 are connected to each other by using a bus.

The memory 1103 is configured to store program code executed by the processor 1102.

The processor 1102 is configured to perform the following operation by using the program code in the memory 1103: generating information about a PRACH time window, where the information about the PRACH time window carries a size of the PRACH time window.

The transceiver 1101 is configured to send the information about the PRACH time window to a terminal.

In the embodiments of the present invention, the bus in FIG. 10 and FIG. 11 is represented by using a bold line, and a manner of a connection between other parts is merely used as an example, and is not limited thereto. The bus may be classified into an address bus, a data bus, a control bus, and the like. For ease of illustration, the bus in FIG. 10 and FIG. 11 is represented by using only one bold line, but it does not mean that there is only one bus or one type of bus.

Referring to FIG. 10 and FIG. 11, the memory in the foregoing embodiments is configured to store the program code executed by the processor. The memory may be a volatile memory (English: volatile memory) such as a random access memory (English: random-access memory, RAM for short); a non-volatile memory (English: non-volatile memory) such as a read-only memory (English: read-only memory, ROM for short), a flash memory (English: flash memory), a hard disk (English: hard disk drive, HDD for short) or a solid state drive (English: solid-state drive, SSD for short); or any other medium that can be used to carry or store expected program code in a form of an instruction or a data structure and that can be accessed by a computer, but the memory is not limited thereto. The memory may be a combination of the foregoing memories.

Referring to FIG. 10 and FIG. 11, the processor in the foregoing embodiments may be a central processing unit (English: central processing unit, CPU for short).

An embodiment of the present invention provides a random access method, to increase an opportunity of performing PRACH access. The method includes: receiving, by a terminal, information about a PRACH time window sent by a base station, where the information about the PRACH time window carries a size of the PRACH time window; preempting, by the terminal, an unlicensed carrier on which a PRACH resource is configured; and performing, by the terminal before the size of the PRACH time window is exceeded, PRACH access on the successfully preempted unlicensed carrier on which the PRACH resource is configured. Therefore, by configuring the PRACH time window, the terminal has more opportunities to preempt the unlicensed carrier on which the PRACH resource is configured, greatly improving a PRACH access success rate.

In addition, in a fast channel access manner proposed in the embodiments of the present invention, a process in which a channel is preempted through LBT is omitted, and a PRACH access success probability is increased. The embodiments of the present invention further propose that an RAR time window is extended or shifted backward, to increase a success rate of preempting a channel by the base station and increase a PRACH access success rate of the terminal. The embodiments of the present invention further propose that the base station notifies the terminal whether the base station successfully preempts the unlicensed subcarrier used for sending the RAR, and that the terminal notifies the base station of a message indicating successful random access of the terminal.

Persons skilled in the art should understand that the embodiments of the present invention may be provided as a method, a system, or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a CD-ROM, an optical memory, and the like) that include computer-usable program code.

The present invention is described with reference to the flowcharts and/or block diagrams of the method, the device (system), and the computer program product according to the embodiments of the present invention. It should be understood that computer program instructions may be used to implement each process and/or each block in the flowcharts and/or the block diagrams and a combination of a process and/or a block in the flowcharts and/or the block diagrams.

These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions may be stored in a computer-readable memory that can instruct the computer or any other programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred embodiments of the present invention have been described, persons skilled in the art can make changes and modifications to these embodiments once they learn the basic inventive concept. Therefore, it is intended that the following claims be construed as covering the preferred embodiments and all changes and modifications falling within the scope of the present invention.

Obviously, persons skilled in the art can make various modifications and variations to the embodiments of the present invention without departing from the spirit and scope of the embodiments of the present invention. In this way, the present invention is intended to cover these modifications and variations provided that they fall within the scope of protection defined by the following claims and their equivalent technologies.

1. A random access method, comprising:
receiving, by a terminal, information about a physical random access channel (PRACH) time window from a base station, the information about the PRACH time window carrying a size of the PRACH time window;
preempting, by the terminal an unlicensed carrier on which a PRACH resource is configured; and
performing, by the terminal before the size of the PRACH time window is exceeded, PRACH access on a successfully preempted unlicensed carrier on which the PRACH resource is configured.

2. The method of claim 1, wherein performing the PRACH access on the successfully preempted unlicensed carrier comprises:
accessing, by the terminal before the size of the PRACH time window is exceeded, the unlicensed carrier on which the PRACH resource is configured;
detecting, by the terminal, the PRACH resource within the PRACH time window; and
sending, by the terminal, a preamble to the base station on a first detected PRACH resource.

3. The method of claim 2, wherein the information about the PRACH time window further carries a configuration rule of the PRACH resource or time-frequency resource information of the PRACH resource within the PRACH time window, and the detecting the PRACH resource within the PRACH time window comprising detecting, by the terminal, the PRACH resource within the PRACH time window based on the configuration rule of the PRACH resource or the time-frequency resource information of the PRACH resource.

4. The method of claim 1, wherein the PRACH resource occupies non-consecutive resource blocks in frequency domain.

5. The method of claim 1, further comprising receiving, by the terminal using Radio Resource Control (RRC) signaling or physical downlink control channel (PDCCH) signaling, the information about the PRACH time window from the base station.

6. The method of claim 1, wherein preempting the unlicensed carrier on which the PRACH resource is configured comprises:
determining, by the terminal, whether a sum of current duration for receiving downlink data and PRACH transmission duration is less than or equal to a maximum channel occupied time;
preempting, by the terminal using a preset channel access manner, the unlicensed carrier on which the PRACH resource is configured when the sum of the current duration for receiving the downlink data and the PRACH transmission duration is less than or equal to the maximum channel occupied time; and
preempting, by the terminal using a category-4 channel access manner, the unlicensed carrier on which the PRACH resource is configured when the sum of the current duration for receiving the downlink data and the PRACH transmission duration is greater than the maximum channel occupied time.

7. The method of claim 2, wherein after sending the preamble to the base station on the first detected PRACH resource, the method further comprises receiving, by the terminal based on a random access response (RAR) time window message, an RAR from the base station when receiving the RAR time window message from the base station, and the RAR time window message carrying a combination of at least one of the following information:
an extension amount of an RAR time window;
a latest size of the RAR time window; or
a subframe offset of the RAR time window.

8. The method of claim 7, wherein the terminal receives, using Radio Resource control (RRC) signaling or physical downlink control channel (PDCCH) signaling, the RAR time window message from the base station.

9. The method of claim 7, wherein after sending the preamble to the base station on the first detected PRACH resource, and before receiving the RAR from the base station, the method further comprises receiving, by the terminal, first indication information from the base station using a licensed carrier, and the first indication information being used for notifying the terminal that the base station successfully preempts an unlicensed carrier used for sending the RAR.

10. The method of claim 7, wherein after receiving the RAR from the base station, the method further comprises sending, by the terminal, hybrid automatic repeat request-acknowledgment (HARQ-ACK) information to the base station using a licensed carrier, and the HARQ-ACK information being used for notifying the base station that the terminal has received the RAR from the base station.

11. The method of claim 2, wherein after sending the preamble to the base station on the first detected PRACH resource, the method further comprises keeping transit power unchanged when the preamble is sent next time when the terminal receives a random access response (RAR) time window message from the base station, when it is determined based on the RAR time window message that an RAR from the base station is not received, and second indication information from the base station using a licensed carrier is received, and the RAR time window message carrying a combination of at least one of the following information:
an extension amount of an RAR time window;
a latest size of the RAR time window; or
a subframe offset of the RAR time window, and
the second indication information being used for notifying the terminal that the base station does not successfully preempt an unlicensed carrier used for sending the RAR.

12. A random access method, comprising:
generating, by a base station, information about a physical random access channel (PRACH) time window, the information about the PRACH time window carrying a size of the PRACH time window; and
sending, by the base station, the information about the PRACH time window to a terminal.

13. The method of claim 12, wherein the information about the PRACH time window further carries a configuration rule of a PRACH resource or time-frequency resource information of the PRACH resource within the PRACH time window.

14. The method of claim 13, wherein the PRACH resource occupies non-consecutive resource blocks in frequency domain.

15. The method of claim 12, further comprising notifying, by the base station, the terminal of the information about the PRACH time window using Radio Resource Control (RRC) signaling or physical downlink control channel (PDCCH) signaling.

16. The method of claim 12, wherein after sending the information about the PRACH time window to the terminal, the method further comprises:
preempting, by the base station, an unlicensed carrier used for sending a random access response (RAR) when the base station receives a preamble from the terminal; and
sending, by the base station before a size of an RAR time window is exceeded, the RAR to the terminal on a successfully preempted unlicensed carrier used for sending the RAR.

17. The method of claim 16, wherein before sending the RAR to the terminal on the successfully preempted unlicensed carrier used for sending the RAR, the method further comprises sending, by the base station, first indication information to the terminal using a licensed carrier, and the first indication information being used for notifying the terminal that the base station successfully preempts the unlicensed carrier used for sending the RAR.

18. The method of claim 16, wherein after sending the RAR to the terminal on the successfully preempted unlicensed carrier used for sending the RAR the method further comprises receiving, by the base station, hybrid automatic repeat request acknowledgement (HARQ-ACK) information from the terminal using a licensed carrier, and the HARQ-ACK information being used for notifying the base station that the terminal has received the RAR from the base station.

19. The method of claim 12, wherein after sending the information about the PRACH time window to the terminal, the method further comprises:
receiving, by the base station, a preamble from the terminal;
preempting, by the base station, an unlicensed carrier used for sending a random access response (RAR); and
sending, by the base station, second indication information to the terminal using a licensed carrier when the base station does not successfully preempt, before a size of an RAR time window is exceeded, the unlicensed carrier used for sending the RAR, the second indication information being used for notifying the terminal that the base station does not successfully preempt the unlicensed carrier used for sending the RAR.

20. The method of claim 17, wherein before preempting unlicensed carrier used for sending the RAR, the method further comprises:
sending, by the base station, an RAR time window message to the terminal, the RAR time window message carrying a combination of at least one of the following information;
an extension amount of the RAR time window;
a latest size of the RAR time window; or
a subframe offset of the RAR time window; and
notifying by the base station the terminal of the RAR time window message using Radio Resource Control (RRC) signaling or physical downlink control channel (PDCCH) signaling.

21.-42. (canceled)
